(19) United States
(12) Patent Application Publication
(10) Pub. No.: US 2002/0152680 A1
(43) Pub. Date: Oct. 24, 2002

(54) Fuel cell power plant

(76) Inventors: Vincent M. Callaghan, West Granby, CT (US); Roger R. Lesieur, Enfield, CT (US); Paul R. Margiott, South Windsor, CT (US)

Correspondence Address: Gregory P. LaPointe, BACHMAN & LaPOINTE, P.C., Suite 1201, 900 Chapel Street, New Haven, CT, 06510-2802, US

(21) Appl. No.: 09/837,503

(22) Filed: Apr. 18, 2001

(51) Int. Cl. B01J 8/00

(52) U.S. Cl. 48/127.9; 48/76; 48/203; 48/197 R; 422/187; 422/188; 422/211; 423/650; 423/651; 423/652; 423/655; 429/17; 429/19

(57) ABSTRACT

A fuel cell system having a water source wherein the water is fed in a controlled manner to a gas stream for cooling the gas stream to a desired temperature. In a preferred embodiment, the water is atomized prior to contacting the gas stream. In a further embodiment, a packing of high surface area material is fed with the cooling water as the gas stream passes through the packing material. By utilizing water already present in the fuel cell power plant, a highly efficient method and system for controlling the temperature of gas streams and O/C ratio in the fuel cell power plant is obtained.

### BACKGROUND OF THE INVENTION

The present invention relates to a fuel cell power plant system and, more particularly, a method and apparatus for controlling the temperature of a reformed gas in a fuel cell power plant system used to produce electricity.

Fuel cells operate at different temperatures depending on the nature of the electrolyte used in the fuel cell. Fuel cells that operate at temperatures below 450° F. include polymer electrolyte membrane fuel cells (PEM), phosphoric acid fuel cells (PAFC), and alkaline fuel cells (AFC). Multicarbonate fuel cells (MCFC) and solid oxide (SOFC) fuel cells generally operate at temperatures in excess of 1200° F.

In these lower temperature fuel cell power plants, the reformed gas exiting temperature is generally 800° F. or higher. The reform process typically uses steam. This steam is added to the fuel process gas upstream of the reformer. Steam is also needed for the shift process. Normally the steam for both is added upstream of the reformer. The steam for the shift connector goes along for the ride through the reformer being heated and subsequently cooled. While this is not harmful to the system, it does tend to lower the reformer efficiency below that of a system with secondary water addition as discussed below. It is necessary to cool the reformed gas to temperatures of generally below 500° F. prior to introducing the reformed gas into a shift converter which converts the reformed gas to a primarily hydrogen and carbon dioxide containing gas stream. The shift converter may be a single stage device or it may be a multi-stage device consisting of a higher temperature unit followed by one or more lower temperature units. Heretofore in prior art fuel cell power plants heat exchangers of the gas/gas type are used to cool the reformed gas to the required temperature. These gas/gas heat exchangers are relatively large in size which is disadvantageous when designing fuel cell systems for vehicle use.

Water is present in most fuel cell power plants and is required to operate the fuel cell efficiently. It would be highly desirable to design a fuel cell power plant which is able to use the water already present in the system to provide cooling for the reformed gas stream prior to feeding same to the shift converter of the power plant.

Accordingly, it is a principle object of the present invention to provide a method and apparatus for controlling the temperature of gas streams in a fuel cell power plant.

It is an additional object of the present invention to provide a method and system as set forth above which utilizes the water already present in the fuel cell power plant system for injecting the additional water necessary for the shift converter as required to support the reaction.

It is a particular object of the present invention to provide a method and system as set forth above which utilizes water already present in the fuel cell power plant system for cooling, in particular, the reformed gas stream.

It is a still further object of the present invention to provide a method and system as set forth above which is relatively compact.

Further objects and advantages of the present invention will appear hereinbelow.

### SUMMARY OF THE INVENTION

The foregoing objects and advantages are obtained by way of the present invention by providing a fuel cell power plant system having a water source wherein the water is fed in a controlled manner to a gas stream for cooling the gas stream to a desired temperature while maintaining a desired gas O/C ratio (oxygen to carbon). In a preferred embodiment, the water is atomized prior to contacting the gas stream. In a further embodiment, a packing of high surface area material is fed with the cooling water as the gas stream passes through the packing material. By utilizing water already present in the fuel cell power plant, a highly efficient method and system for controlling the temperature and O/C ratios of gas streams in the fuel cell power plant is obtained.

### BRIEF DESCRIPTION OF THE DRAWINGS

Further features and advantages of the present invention will be more fully apparent in light of the following detailed description of the preferred embodiment of the present invention as illustrated in the accompanying drawings wherein:

FIG. 1 is a partial schematic illustration of a fuel cell power plant system in accordance with the present invention.

FIG. 2 is a cross sectional view through a water fed precooler used in the preferred embodiment of the present invention.

### DETAILED DESCRIPTION

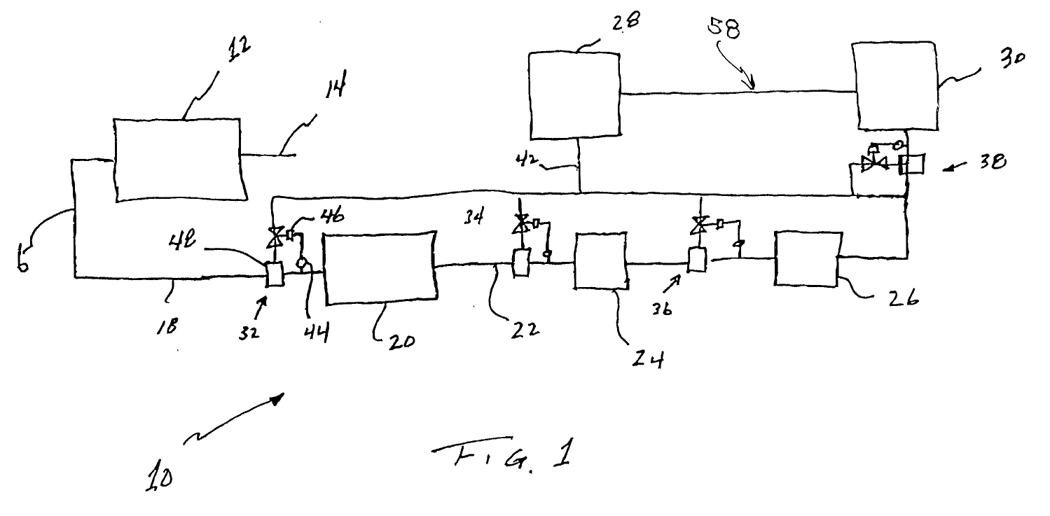

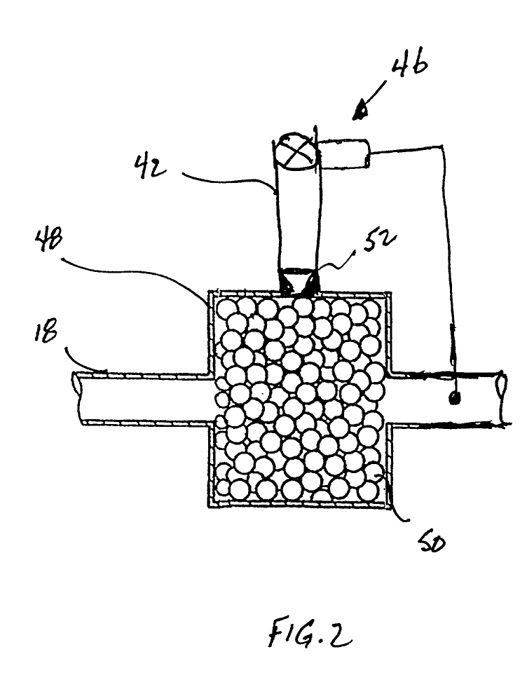

The process and the apparatus of the present invention will be described hereinbelow with reference to FIGS. 1 and 2.

FIG. 1 is a schematic representation of a fuel cell power plant which may employ the water cooling and O/C ratio control features of the present invention. It should be appreciated that the water cooling and O/C ratio control systems of the present invention may be used in any fuel cell system with a fuel processor using fuels such as natural gas, gasoline, diesel fuel, naphtha, fuel oil and like hydrocarbons. The fuel cell may be of any type known in the prior art, however, the cooling system of the present invention is particularly usable in PEM fuel cell power plants and phosphoric acid fuel cell plants.

With reference to FIG. 1, the fuel cell power plant system 10 includes a fuel processor 12 (this may include devices such as a catalytic steam reformer, auto-thermal reformer or catalytic partial oxidation device or the like as commonly known in the art which receives a gas mixture via 14 comprising, for example, gasoline, steam and air which is reformed in the fuel processor (auto-thermal reformer) to produce a reformed gas comprising primarily nitrogen, hydrogen, carbon dioxide water vapor and carbon monoxide. The hot reformed gas discharged via 18 from the reformer via 16 is generally at a temperature of between 800 and 1200° F. depending on the type of fuel processor employed. A shift converter 20 receives the reformed gas and processes the reformed gas in the presence of the catalyst to convert the majority of the carbon monoxide in the reformed gas such that the gas exiting the shift converter 20 via line 22 is primarily a gas mixture of hydrogen and carbon dioxide. The gas stream leaving the shift converter 20 is thereafter fed to a fuel cell 30 wherein the gas stream is converted into electrical power. In typical fuel cell power plant systems, one or more selective oxidizers 24 and 26 may be located between the shift converter 20 and the fuel cell 30. Any remaining carbon monoxide in the gas stream via 22 from the shift converter 20 can be further reduced prior to feeding the gas stream to the fuel cell 30.

It is necessary to cool the reformed gas stream discharge from the fuel processor 12 via line 16 prior to feeding the reformed gas to the shift converter 20.

In accordance with the present invention, the reformed gas is cooled by injecting into the reformed gas stream, water in a controlled manner. Again with reference to FIG. 1, a water source 28 is provided for communicating water to the gas stream at various points 32, 34, 36 and 38 between the fuel processor 12 and the fuel cell 30 as necessary to insure proper operation of the fuel cell power plant system. As illustrated in FIG. 1 water from the water source 28 is fed by a line 42 to the conduit 18 carrying the reformed gas from the fuel processor 12 to the shift converter 20. The water is fed in a controlled manner so as to insure that the temperature of the reformed gas stream entering the shift converter is at the desired temperature and that the O/C ratio is controlled in accordance with the set temperature. In order to insure the foregoing, a sensor 44 is provided in the conduit 18 immediately upstream of the shift converter 20 for sensing the temperature of the reformed gas stream. The sensed temperature is compared to a desired temperature in a known manner and the valve 46 is controlled so as to adjust the flow of water into the conduit in order to insure the proper cooling of the gas stream while maintaining a desired O/C ratio. Such control systems for sensing temperature of a gas stream and controlling a flow valve in response to the sensed temperature are well known in the art.

In accordance with the preferred embodiment of the present invention as shown in FIG. 1 and FIG. 2, a chamber 48 may be provided in the conduit for receiving the water fed from the water source 28. The chamber 48 may be packed with a high surface area material 50 which assists, with the water, in cooling the reformed gas stream to the desired temperature. Suitable high surface area materials include ceramic pellets, steel wool, reticulated ceramic foam, metallic foam and honeycomb monoliths. It is preferred that the water be injected into the gas stream through a nozzle 52 which atomizes the water into small droplets. The nozzle 52 may take the form of any nozzle known in the art and should be designed to provide water droplets of less than about 100 microns at rated flow conditions which are about 27 lbs./hr. of H₂O. In this way the water may be distributed in a substantially uniform manner onto the high surface area material 50 so as to increase cooling efficiency. It has been found that relatively small amounts of water are required to effectively cool the gas stream. In a PEM cell power plant, for example, to cool 250 pph of reformed gas from 660° F. to 400° F., 27 pph of water at a temperature of 140° F. is required. However, it should be noted that the key to this temperature control device is the water phase change in the form of evaporating and not the inlet water temperature. Water temperature for phosphoric acid cell power plant would more likely be in the 300° F. range.

Water from the water source may be injected at other points 34, 36, 38 along the flow of the gas stream from the shift converter 20 to the fuel cell 30 if desired. Particularly, as shown in FIG. 1, when selective oxidizers 24, 26 are used for further reduction of carbon monoxide, it is beneficial to have additional cooling chambers 48 either with or without the high surface area material upstream of the selective oxidizers for further cooling of the gas stream prior to introduction thereto. The cooling chambers may contain a high surface area material as described above. The control system for temperature sensing and controlling the flow of water to the gas stream is, again, as described above and may be of any well known temperature control valve system known in the art. In the case of a multi-stage shift converter, additional injection points would be possible for temperature control within the multi-stage unit.

The operation of the fuel cell is not adversely affected by the presence of water in the feed to the fuel cell. In fact, water is required in most fuel cells so as to provide efficient operation thereof. However, it is desired that the dew point of the reformed gas not be increased significantly, that is, less than 10° F. so as to avoid condensation in the system. Water may be recovered from the fuel cell 30 and recycled to the water source 28 via line 58 for further use in the fuel cell power plants system.

The system of the present invention has a number of advantages. Firstly, it eliminates the need for large heat exchangers typically used in the prior art. Secondly, it uses a water source for cooling which is generally already present in the power plant fuel cell system. Finally, it has been found that the size of the shift converter may be reduced as the reaction H₂O+CO→H₂+CO₂ is favored with increased water.

This invention may be embodied in other forms or carried out in other ways without departing from the spirit or essential characteristics thereof. The present embodiment is therefore to be considered as in all respects illustrative and not restrictive, the scope of the invention being indicated by the appended claims, and all changes which come within the meaning and range of equivalency are intended to be embraced therein.

What is claimed is:

1. A fuel cell system comprising a fuel processor for converting a hydrocarbon fuel into a high temperature reformed gas containing hydrogen, carbon dioxide and carbon monoxide, first conduit means for communicating the reformed gas to a shift converter located downstream of the fuel processor for further converting the reformed gas to primarily a hydrogen and carbon dioxide containing gas stream, second conduit means for communicating the gas stream to a fuel cell downstream of the shift converter for reacting the hydrogen in the gas stream, a water source, and water feed means for feeding water to at least one of the first and second conduit means in a controlled manner for cooling at least one of the reformed gas and gas stream, respectively, to a desired temperature.

2. A fuel cell system according to claim 1, wherein the water added to the reformed gas sets the desired oxygen/carbon ratio for the shift converter.

3. A fuel cell system according to claim 2, wherein the water feed means includes control means for controlling the feeding of water to at least one of the first and second conduit means.

4. A fuel cell system according to claim 3, wherein the control means senses the temperature of the reformed gas and gas stream, respectively, and feeds water to at least one of the first and second conduits, respectively, in response to the sensed temperature.

5. A fuel cell system according to claim 1, further including means for collecting water from the fuel cell and recycling at least a portion of the collected water as the water source.

6. A fuel cell system according to claim 2, further including at least one selective oxidizer, between the shift converter and the fuel cell, and located downstream of where the water feed means feeds water to the second conduit means.

7. A fuel cell system according to claim 4, wherein the control means further includes at least one solenoid valve which opens and closes in response to the sensed temperature.

8. A fuel cell system according to claim 3, wherein the water feed means includes means to atomize the water.

9. A fuel cell system according to claim 2, wherein at least one of the first and second conduit means includes a packing of high surface area material and the water is fed to the material.

10. A fuel cell system according to claim 9, wherein said high surface area material is selected from the group consisting of ceramic pellets, steel wool, reticulated ceramic foam, metal foam, and honeycomb monoliths.

11. A fuel cell system according to claim 2, wherein water is fed to both the first conduit and the second conduit.

12. A method for controlling temperature in a fuel cell system comprising a fuel processor for generating a reformed gas, a shift converter downstream of the fuel processor for receiving the reformed gas via a first conduit and further converting same to a primarily hydrogen and carbon dioxide containing gas stream, and a fuel cell downstream of the shift converter for receiving the gas stream via a second conduit, comprising the steps of providing a water source and injecting water from the water source into at least one of the reformed gas and the gas stream respectively, in a controlled manner for cooling the reformed gas and gas stream to a desired temperature prior to feeding the reformed gas to the shift converter and the gas stream to the fuel cell.

13. A method according to claim 12, including collecting water from the fuel cell are recycling at least a portion thereof to the water source.

14. A method according to claim 12, including atomizing the water during injection.

15. A method according to claim 12, including providing a packing of high surface area material in at least one of the first conduit and second conduit and injecting the water on the packing bed.

16. A method according to claim 12, including controlling the water injection to set the desired oxygen/carbon ratio which minimizes excess steam injection into the fuel processor so as to improve efficiency of the power plant.
